(19) United States
(12) Patent Application Publication
(10) Pub. No.: US 2017/0152881 A1
(43) Pub. Date: Jun. 1, 2017

(54) SCREW

(71) Applicant: Hui-Ju YANG, Tainan (TW)

(72) Inventor: Hui-Ju YANG, Tainan (TW)

(21) Appl. No.: 14/953,138

(22) Filed: Nov. 27, 2015

(51) Int. Cl. F16B 25/10; F16B 25/00

(52) U.S. Cl. CPC F16B 25/103; F16B 25/0015

(57) ABSTRACT

A screw has a circular rod, a pointed cone, a head, a first threaded portion, a second threaded portion and a third threaded portion, wherein the pointed cone is formed on a first portion of the circular rod, the head is formed on a second portion of the circular rod, the first threaded portion is formed from the pointed cone to the first portion and has two first threads having a first pitch, the second threaded portion is formed on the circular rod and has a second thread having a second pitch, the third threaded portion is formed on the circular rod and has a third thread having a third pitch, the first pitch is longer than the second pitch and the third pitch, the configuration of which provides a screw to drill and screw into multiple wooden workpieces steadily and quickly.

### BACKGROUND OF THE INVENTION

1. Field of the Invention

The present invention relates to a screw, and more particularly to a screw that is screwed into multiple wooden workpieces to fasten the wooden workpieces.

2. Description of Related Art

A structure of a conventional screw varies according to the purposes and the functions. For example, the conventional screw is screwed into multiple wooden workpieces and has a circular rod, a pointed cone, a head, and a threaded portion. The circular rod has a first portion and a second portion. The second portion of the circular rod is opposite to the first portion of the circular rod. The pointed cone is formed on the first portion of the circular rod. The head is formed on the second portion of the circular rod. The threaded portion is formed on two external surfaces of the circular rod and the pointed cone.

In use, a hand tool or an electric tool is connected to the head of the conventional screw and rotates the conventional screw to enable the pointed cone and the threaded portion of the conventional screw to drill and tap the wooden workpieces. Therefore, the conventional screw can be screwed into and fasten the wooden workpieces.

Although the conventional screw may provide a fastening effect to the wooden workpieces, the threaded portion of the conventional screw has a thread formed between the circular rod and the pointed cone, and the threaded portion of the conventional screw has multiple pitches. The pitches are equal. However, in the beginning of screwing the conventional screw into the wooden workpieces, the conventional screw is difficult to drill into the wooden workpieces. The stability of drilling the conventional screw into the wooden workpieces is insufficient.

Furthermore, the diameter of the threaded portion located at the circular rod is identical, and the pitches of the threaded portion located at the circular rod are equal. During the drilling process of the conventional screw screwed into the wooden workpieces, the chips produced by the wooden workpieces may not be easy to discharge, and the wooden workpieces may be cleaved easily.

To overcome the shortcomings, the present invention tends to provide a screw to mitigate or obviate the aforementioned problems.

### SUMMARY OF THE INVENTION

The main objective of the invention is to provide a screw that may drill and screw into multiple wooden workpieces quickly and steadily.

The screw has a circular rod, a pointed cone, a head, a first threaded portion, a second threaded portion, and a third threaded portion. The circular rod has a center axis, a first portion and a second portion. The first portion and the second portion are respectively formed on two ends of the circular rod. The pointed cone is formed on the first portion of the circular rod and has an outer surface. The head is formed on the second portion of the circular rod. The first threaded portion is spirally formed from the outer surface of the pointed cone to an outer surface of the first portion of the circular rod. The first threaded portion has two first threads. The first threads form at least one spiral circle and each one of the first threads has a first pitch. The second threaded portion is spirally formed on the circular rod, is adjacent to the first portion, and has a second thread. The second thread forms multiple spiral circles and has a second pitch. The second pitch of the second thread is shorter than the first pitch of each one of the first threads. The third threaded portion is spirally formed on the circular rod, is connected to the second thread of the second threaded portion, extends to the head, and has a third thread. The third thread forms multiple spiral circles and has a third pitch. The third pitch of the third thread is shorter than the first pitch of each one of the first threads.

The first threaded portion has two first threads to form at least one spiral circle, and the first pitch of each one of the first threads is longer than the second pitch and the third pitch. The screw can be steadily and quickly drilled into multiple wooden workpieces, and then the screw taps a hole in each one of the wooden workpieces. The first threaded portion with the two first threads presses a wall which is formed around the hole in each one of the wooden workpieces to ream the hole in each one of the wooded workpieces. After the pointed cone and the first threaded portion tap into the wooden workpieces, the second threaded portion and the third second threaded portion are screwed into the wooden workpieces sequentially. The chips produced by the wooden workpieces are discharged easily.

Furthermore, the first threaded portion has a first major diameter. The second threaded portion has a second major diameter. The third threaded portion has a third major diameter. The third major diameter is larger than the first major diameter and the second major diameter. The second major diameter is equal to or smaller than the first major diameter. The screw can be screwed into the wooden workpieces while gradually reaming the hole in each one of the wooden workpieces. The screw can avoid cleaving the wooden workpieces during tapping.

Moreover, the screw has a perpendicular line. The perpendicular line is perpendicular to the center axis of the circular rod. Each one of the first threads has a first flank, a second flank, a first included angle and a second included angle. The first flank faces toward the head. The second flank faces toward a tip of the pointed cone. The first included angle is defined between the first flank and the perpendicular line of the circular rod. The second included angle is defined between the second flank and the perpendicular line of the circular rod. The second included angle is larger than the first included angle. Therefore, an inclined angle between the second flank and the center axis of the circular rod is smaller than an inclined angle between the first flank and the center axis of the circular rod, and this may reduce a rotating torque of the screw during tapping. The screw may be easily screwed into the wooden workpieces.

### BRIEF DESCRIPTION OF THE DRAWINGS

FIG. 1 is a perspective view of a screw in accordance with the present invention;

FIG. 2 is a side view of the screw in FIG. 1;

FIG. 3 is a bottom view of the screw in FIG. 1;

FIG. 4 is an enlarged side view of the screw in FIG. 1;

FIG. 5 is an operational side view of the screw in FIG. 1, drilled into a wooden workpiece; and

FIG. 6 is another operational side view of the screw in FIG. 1, drilled into multiple wooden workpieces.

### DETAILED DESCRIPTION OF PREFERRED EMBODIMENT

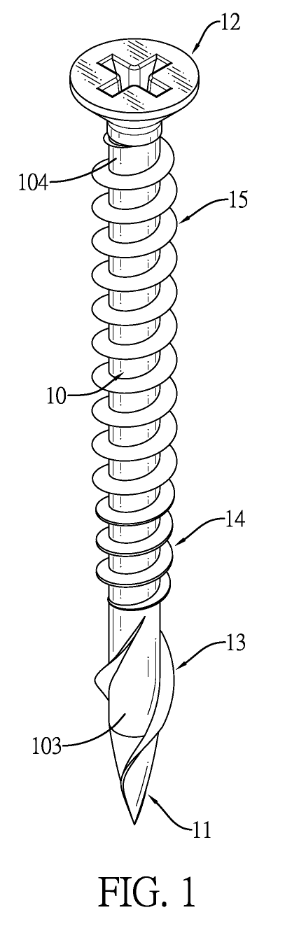

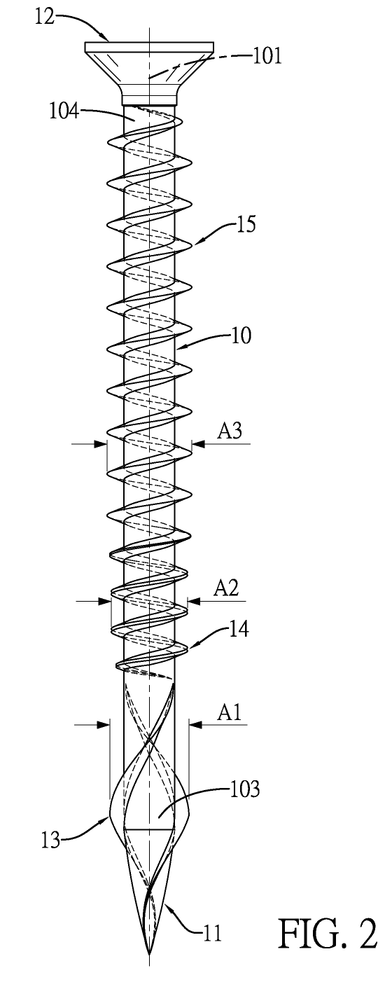

With reference to FIGS. 1 and 2, a screw in accordance with the present invention comprises a circular rod 10, a pointed cone 11, a head 12, a first threaded portion 13, a second threaded portion 14, and a third threaded portion 15.

The circular rod 10 has a center axis 101, a first portion 103, and a second portion 104. The first portion 103 and the second portion 104 are respectively formed on two ends of the circular rod 10 along the center axis 101. The pointed cone 11 is formed on the first portion 103 of the circular rod 10 and has an outer surface. The head 12 is formed on the second portion 104 of the circular rod 10. An outer diameter of the head 12 is larger than a diameter of the circular rod 10. The head 12 has an end surface and a tool hole. The tool hole is formed in the end surface of the head 12. The tool hole may be a slotted tool hole or a Phillips tool hole. In addition, the tool hole may be polygonal or any other shape. The head 12 is connected to a hand tool or an electric tool via the tool hole.

The first threaded portion 13 is a double-start thread type. The first threaded portion 13 is spirally formed from the outer surface of the pointed cone 11 to an outer surface of the first portion 103 of the circular rod 10. The second threaded portion 14 is a single-start thread type. The second threaded portion 14 is spirally formed on the circular rod 10 beside the first threaded portion 13 and is adjacent to the first portion 103. The third threaded portion 15 is a single-start thread type. The third threaded portion 15 is spirally formed on the circular rod 10, is connected to the second threaded portion 14, and extends to the head 12.

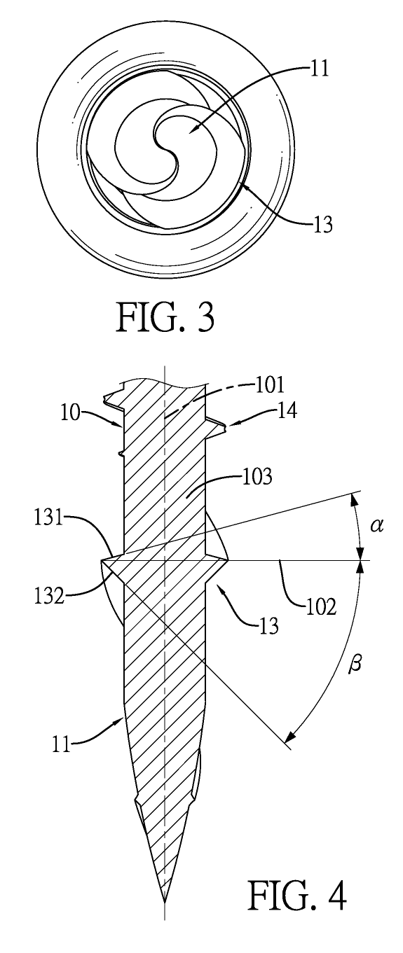

With reference to FIGS. 1 to 3, the first threaded portion 13 has two first threads to form at least one spiral circle. Each one of the first threads has a first pitch. The second threaded portion 14 has a second thread to form multiple spiral circles. The second thread has a second pitch. The third threaded portion 15 has a third thread to form multiple spiral circles. The third thread has a third pitch. The first pitch of each one of the first threads is longer than the second pitch of the second thread and the third pitch of the third thread. With further reference to FIG. 2, the first threaded portion 13 has a first major diameter A1. The second threaded portion 14 has a second major diameter A2. The third threaded portion 15 has a third major diameter A3. The second major diameter A2 is smaller than or equal to the first major diameter A1 of the first threaded portion 13. The third major diameter A3 of the third threaded portion 15 is larger than the first major diameter A1 of the first threaded portion 13 and the second major diameter A2 of the second threaded portion 14. In the preferred embodiment, the third major diameter A3 of the third threaded portion 15 is larger than the first major diameter A1 of the first threaded portion 13. The first major diameter A1 of the first threaded portion 13 is larger than the second major diameter A2 of the second threaded portion 14. Furthermore, the second pitch of the second threaded portion 14 is shorter than the third pitch of the third threaded portion 15.

With reference to FIGS. 2 and 4, each one of the first threads, the second thread, and the third thread has a triangular cross section. The screw has a perpendicular line 102. The perpendicular line 102 is perpendicular to the center axis 101 of the circular rod 10. Each one of the first threads has a crest, a first flank 131, a second flank 132, a first included angle α, and a second included angle β. The crest is helically disposed outside an outer surface of the circular rod 10. The first flank 131 faces toward the head 12 and is connected to the crest and the outer surface of the circular rod 10. The second flank 132 faces toward a tip of the pointed cone 11 below the first flank 131, and is connected to the crest and the outer surface of the circular rod 10. The first included angle α is defined between the first flank 131 and the perpendicular line 102. The second included angle β is defined between the second flank 132 and the perpendicular line 102. The second included angle β is larger than the first included angle α. In addition, the first included angle α ranges from 10 to 15 degrees, and the second included angle β ranges from 30 to 45 degrees.

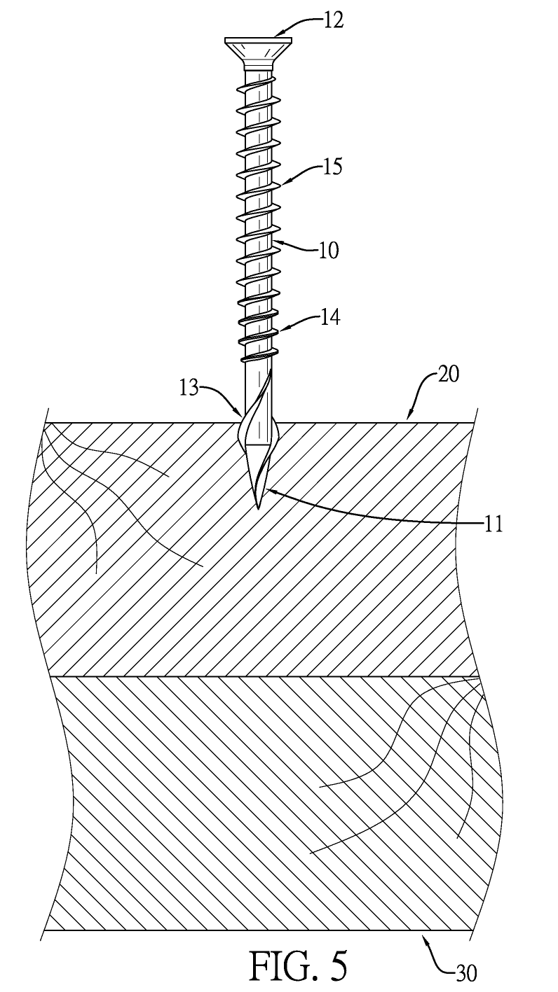

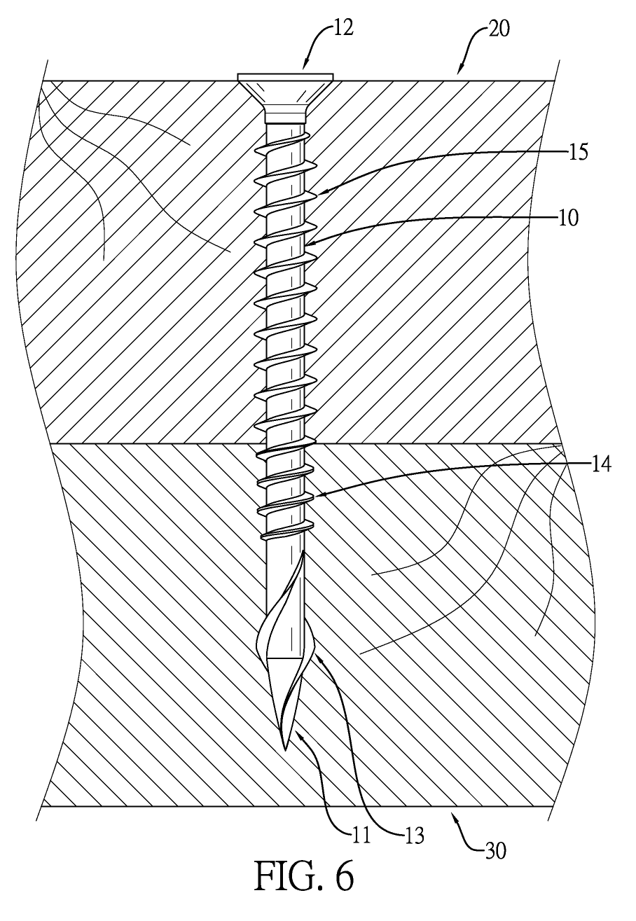

With reference to FIGS. 5 and 6, the screw is used to fasten multiple wooden workpieces 20, 30. The head 12 is connected to and is rotated by the hand tool or the electric tool to rotate the screw to screw into the wooden workpieces 20, 30. The first threaded portion 13 is formed from the outer surface of the pointed cone 11 to the outer surface of the first portion 103 of the circular rod 10. The first pitch of each one of the first threads is longer than the second pitch of the second thread and the third pitch of the third thread. The screw may be steadily and quickly drilled into the wooden workpieces 20, 30. At the same time, the screw taps a hole in each one of the wooden workpieces 20, 30, the first threaded portion 13 with the two first threads presses a wall which is formed around the hole in each one of the wooden workpieces 20, 30 to ream the hole in each one of the wooden workpieces 20, 30. The screw has functions of drilling, tapping, reaming and fastening. After the pointed cone 11 and the first threaded portion 13 are tapped into the wooden workpieces 20, 30, the second threaded portion 14 and the third threaded portion 15 are screwed into the wooden workpieces 20, 30 sequentially. The second major diameter A2 of the second threaded portion 14 is equal to or smaller than the first major diameter A1 of the first threaded portion 13. The chips produced by the wooden workpieces 20, 30 may be easily discharged through a space between the second threaded portion 14, the third threaded portion 15, and the outer surface of the circular rod 10.

Additionally, the third major diameter A3 of the third threaded portion 15 is larger than the first major diameter A1 of the first threaded portion 13. The first major diameter A1 of the first threaded portion 13 is larger than the second major diameter A2 of the second threaded portion 14. When the first threaded portion 13 is screwed into the wooden workpieces 20, 30, the second threaded portion 14 and the third threaded portion 15 are sequentially reamed and tapped into the wooden workpieces 20, 30 to prevent the wooden workpieces 20, 30 from cleaving.

With reference to FIGS. 4 to 6, in each one of the first threads of the first threaded portion 13, the second included angle β is larger than the first included angle α. Therefore, an inclined angle between the second flank 132 and the center axis 101 of the circular rod 10 is smaller than an inclined angle between the first flank 131 and the center axis 101 of the circular rod 10, and this may reduce a rotating torque of the screw during tapping. Then, the screw may be easily screwed into the wooden workpieces 20, 30.

What is claimed is:

1. A screw comprising:
a circular rod having
a center axis;
two ends opposite to each other;
a first portion formed on one of the two ends of the circular rod along the center axis; and
a second portion formed on the other end of the circular rod along the center axis;
a pointed cone formed on the first portion of the circular rod and having an outer surface;
a head formed on the second portion of the circular rod;
a first threaded portion spirally formed from the outer surface of the pointed cone to an outer surface of the first portion of the circular rod and having
two first threads forming at least one spiral circle, and each one of the first threads having a first pitch;
a second threaded portion spirally formed on the circular rod, being adjacent to the first portion, and having
a second thread forming multiple spiral circles and having
a second pitch shorter than the first pitch of each one of the first threads; and
a third threaded portion spirally formed on the circular rod, connected to the second thread of the second threaded portion, extending to the head, and having
a third thread forming multiple spiral circles and having
a third pitch shorter than the first pitch of each one of the first threads.

2. The screw as claimed in claim 1, wherein
the first threaded portion has a first major diameter;
the second threaded portion has
a second major diameter smaller than the first major diameter of the first threaded portion; and
the third threaded portion has
a third major diameter larger than the first major diameter of the first threaded portion and the second major diameter of the second threaded portion.

3. The screw as claimed in claim 1, wherein
the first threaded portion has a first major diameter;
the second threaded portion has
a second major diameter equal to the first major diameter of the first threaded portion; and
the third threaded portion has
a third major diameter larger than the first major diameter of the first threaded portion and the second major diameter of the second threaded portion.

4. The screw as claimed in claim 1, wherein the second pitch of the second thread is shorter than the third pitch of the third thread.

5. The screw as claimed in claim 2, wherein the second pitch of the second thread is shorter than the third pitch of the third thread.

6. The screw as claimed in claim 3, wherein the second pitch of the second thread is shorter than the third pitch of the third thread.

7. The screw as claimed in claim 1, wherein
the screw has a perpendicular line perpendicular to the center axis of the circular rod;
each one of the first threads has
a triangular cross section;
a first flank facing toward the head;
a second flank facing toward a tip of the pointed cone;
a first included angle defined between the first flank and the perpendicular line of the circular rod; and
a second included angle defined between the second flank and the perpendicular line of the circular rod, and being larger than the first included angle;
the second thread has a triangular cross section; and
the third thread has a triangular cross section.

8. The screw as claimed in claim 2, wherein
the screw has a perpendicular line perpendicular to the center axis of the circular rod;
each one of the first threads has
a triangular cross section;
a first flank facing toward the head;
a second flank facing toward a tip of the pointed cone;
a first included angle defined between the first flank and the perpendicular line of the circular rod; and
a second included angle defined between the second flank and the perpendicular line of the circular rod, and being larger than the first included angle;
the second thread has a triangular cross section; and
the third thread has a triangular cross section.

9. The screw as claimed in claim 3, wherein
the screw has a perpendicular line perpendicular to the center axis of the circular rod;
each one of the first threads has
a triangular cross section;
a first flank facing toward the head;
a second flank facing toward a tip of the pointed cone;
a first included angle defined between the first flank and the perpendicular line of the circular rod; and
a second included angle defined between the second flank and the perpendicular line of the circular rod, and being larger than the first included angle;
the second thread has a triangular cross section; and
the third thread has a triangular cross section.

10. The screw as claimed in claim 4, wherein
the screw has a perpendicular line perpendicular to the center axis of the circular rod;
each one of the first threads has
a triangular cross section;
a first flank facing toward the head;
a second flank facing toward a tip of the pointed cone;
a first included angle defined between the first flank and the perpendicular line of the circular rod; and
a second included angle defined between the second flank and the perpendicular line of the circular rod, and being larger than the first included angle;
the second thread has a triangular cross section; and
the third thread has a triangular cross section.

11. The screw as claimed in claim 5, wherein
the screw has a perpendicular line perpendicular to the center axis of the circular rod;
each one of the first threads has
a triangular cross section;
a first flank facing toward the head;
a second flank facing toward a tip of the pointed cone;
a first included angle defined between the first flank and the perpendicular line of the circular rod; and
a second included angle defined between the second flank and the perpendicular line of the circular rod, and being larger than the first included angle;
the second thread has a triangular cross section; and
the third thread has a triangular cross section.

12. The screw as claimed in claim 6, wherein
the screw has a perpendicular line perpendicular to the center axis of the circular rod;
each one of the first threads has
a triangular cross section;
a first flank facing toward the head;
a second flank facing toward a tip of the pointed cone;
a first included angle defined between the first flank and the perpendicular line of the circular rod; and
a second included angle defined between the second flank and the perpendicular line of the circular rod, and being larger than the first included angle;
the second thread has a triangular cross section; and
the third thread has a triangular cross section.

13. The screw as claimed in claim 7, wherein the first included angle ranges from 10 to 15 degrees, and the second included angle ranges from 30 to 45 degrees.

14. The screw as claimed in claim 8, wherein the first included angle ranges from 10 to 15 degrees, and the second included angle ranges from 30 to 45 degrees.

15. The screw as claimed in claim 9, wherein the first included angle ranges from 10 to 15 degrees, and the second included angle ranges from 30 to 45 degrees.

16. The screw as claimed in claim 10, wherein the first included angle ranges from 10 to 15 degrees, and the second included angle ranges from 30 to 45 degrees.

17. The screw as claimed in claim 11, wherein the first included angle ranges from 10 to 15 degrees, and the second included angle ranges from 30 to 45 degrees.

18. The screw as claimed in claim 12, wherein the first included angle ranges from 10 to 15 degrees, and the second included angle ranges from 30 to 45 degrees.
